(19) United States
(12) Patent Application Publication
(10) Pub. No.: US 2023/0167854 A1
(43) Pub. Date: Jun. 1, 2023

(54) TOOL HOLDER BEARING LOCKING DEVICE

(71) Applicant: SHIN-YAIN INDUSTRIAL CO., LTD., TAICHUNG CITY (TW)

(72) Inventor: PEN HUNG CHEN, TAICHUNG CITY (TW)

(21) Appl. No.: 17/536,641

(22) Filed: Nov. 29, 2021

(51) Int. Cl. F16C 33/46; F16C 19/26

(52) U.S. Cl. CPC F16C 33/46; F16C 19/26

(57) ABSTRACT

A tool holder bearing locking device has a stand and a locking collar mounted on a top of the stand. The locking collar has a main body, a retainer, multiple rollers, and an end cover. The main body has a chamber and multiple concave recesses annularly arranged around the chamber, communicating with the chamber, and connected with each other to form a multi-lobed groove. The retainer is mounted in the chamber and has multiple separating rods and multiple roller containing spaces formed between the separating rods. The rollers are respectively mounted in the roller containing spaces. The end cover is fastened on the top of the main body. The tool holder bearing locking device fastens a tool holder by the rollers.

### BACKGROUND OF THE INVENTION

### 1. Field of the Invention

The present invention relates to a tool holder locking device, and more particularly to a tool holder bearing locking device that fastens a tool holder by multiple rollers.

### 2. Description of the Prior Art

A conventional tool holder locking device is a device to assist changing and retrieval of a tool clamped in a tool holder. The conventional tool holder locking device substantially has a positioning block to engage with a positioning notch recessed in an outer peripheral surface of a tool holder to prevent the tool holder from rotating relative to the conventional tool holder locking device during fastening or loosening a nut connecting with the tool holder. However, the conventional tool holder locking device is not suitable for fixing a tool holder without any positioning notch.

To change a cutter clamped in the tool holder without a positioning notch, the tool holder is tightly clamped by a clamping device, such as a vice, or is fixed by frictional resistance. For this reason, the tool holder is easily damaged.

To overcome the shortcomings, the present invention provides a tool holder bearing locking device to mitigate or obviate the aforementioned problems.

### SUMMARY OF THE INVENTION

The main objective of the present invention is to provide a tool holder bearing locking device that has simple structures and fastens a tool holder via multiple rollers abutting against a peripheral surface of the tool holder to reduce friction and to avoid damaging the tool holder.

To achieve the foregoing purpose, the tool holder bearing locking device comprises a stand and a locking collar mounted on a top of the stand. The locking collar has a main body, a retainer, multiple rollers, and an end cover. The main body is mounted on the top of the stand and has a chamber, a through hole, and multiple concave recesses. The chamber is formed downwardly from a top of the main body and is spaced apart, from a bottom of the main body. The through hole is formed through a bottom surface of the chamber and the bottom of the main body to form a body flange between the bottom surface of the chamber and the bottom of the main body. The concave recesses are arranged around the chamber, communicate with the chamber, and are connected with each other to form a multi-lobed groove.

The retainer is rotatably mounted in the chamber of the main body and has a base ring, multiple separating rods arranged annularly at angular intervals and extending upwardly from the base ring, and multiple roller containing spaces formed between the separating rods. Each of the roller containing spaces corresponds to a respective one of the concave recesses in position and has an outer opening facing an outer periphery of the retainer and an inner opening facing an inner periphery of the retainer. The rollers are respectively and vertically placed in the roller containing spaces of the retainer. Each of the rollers is rotatably and movably retained between a corresponding one of the roller containing spaces of the retainer and a corresponding one of the concave recesses of the main body and partially exposed from the inner opening of the corresponding roller containing space. The end cover is mounted on the top of the main body to retain the retainer and the rollers between the main body and the end cover.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tool holder bearing locking device in accordance with the present invention;

FIG. 2 is an enlarged exploded perspective view in partial section of the tool holder bearing locking device in FIG. 1;

FIG. 3 is a cross sectional side view of the tool holder bearing locking device in FIG. 1;

FIG. 4 is a cross sectional top view of the tool holder bearing locking device in FIG. 1;

FIG. 5 is a perspective view in partial section of a main body of the tool holder bearing locking device in FIG. 2;

FIG. 6 is an operational cross sectional top view of the tool holder bearing locking device in FIG. 4 showing that a tool holder is fastened;

FIG. 7 is an operational perspective view of the tool holder bearing locking device in FIG. 1 showing that a tool holder is fastened; and

FIG. 8 is an exploded perspective view of the tool holder bearing locking device in FIG. 2 showing four selectable locking collars.

### DETAILED DESCRIPTION OF THE PREFERRED EMBODIMENTS

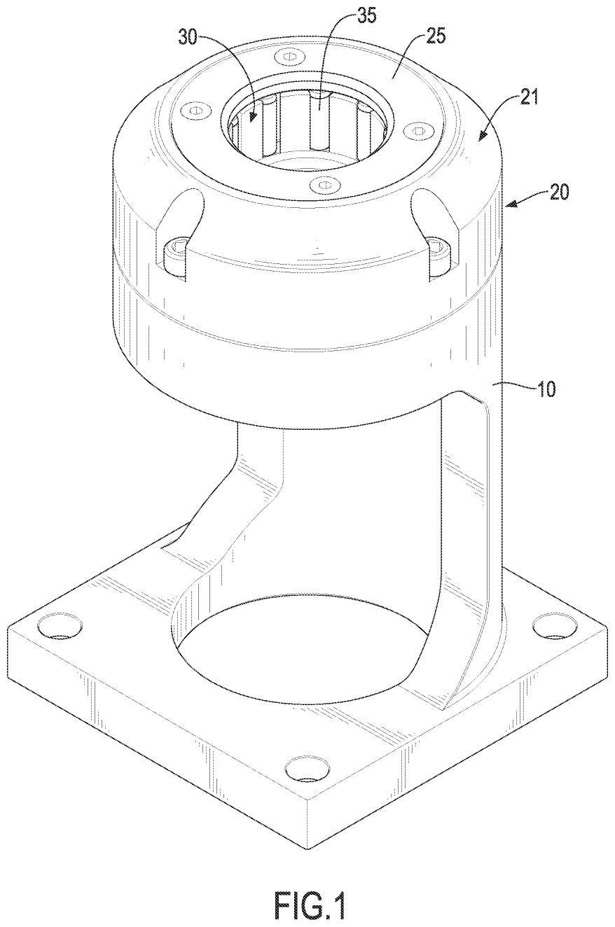

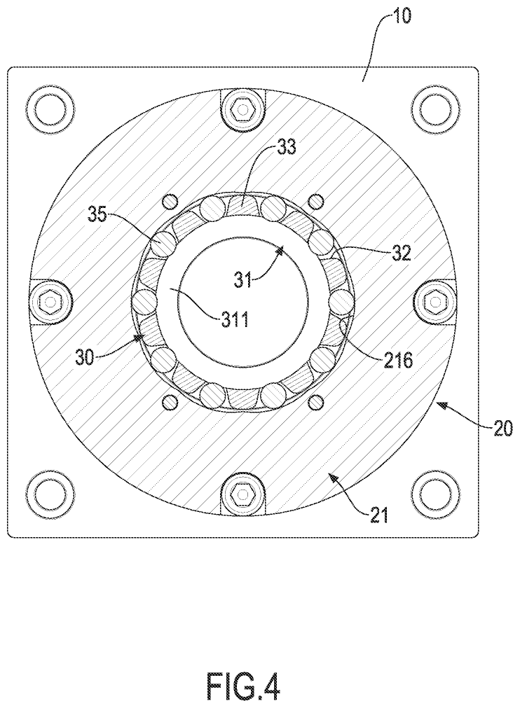

With reference to FIGS. 1 to 4, a tool holder bearing locking device in accordance with the present invention comprises a stand 10 and a locking collar 20. The locking collar 20 is mounted on a top of the stand 10. Preferably, the locking collar 20 is detachably mounted on the top of the stand 10, so the locking collar 20 is changeable. The locking collar 20 may be detachably fastened on the top of the stand 10 with multiple bolts.

The locking collar 20 has a main body 21, a retainer 30, multiple rollers 35, and an end cover 25.

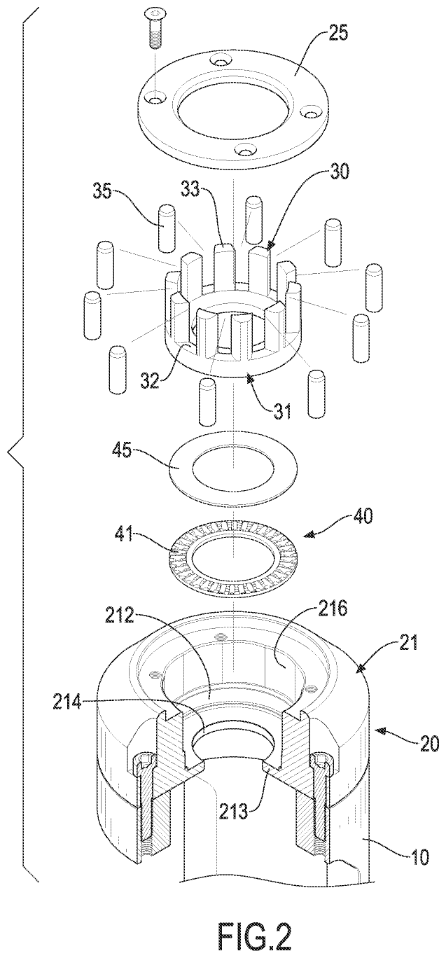

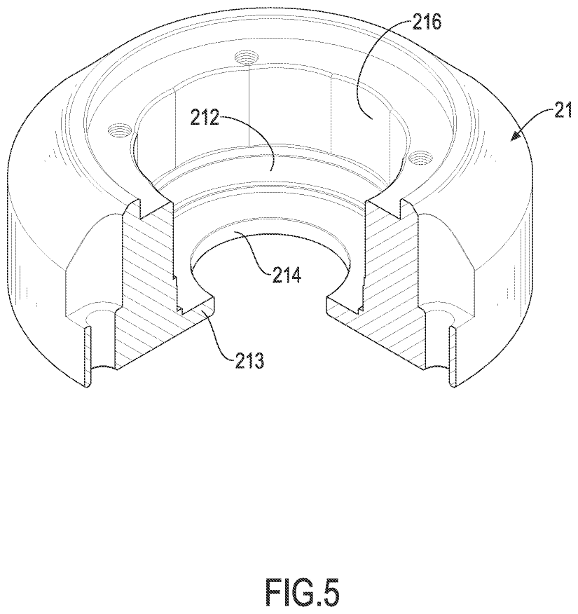

With reference to FIGS. 2, 4, and 5, the main body 21 is detachably mounted on the top of the stand 10. The main body 21 has a chamber 212, a through hole 214, and multiple concave recesses 216. The chamber 212 is formed downwardly from a top of the main body 21 and is spaced apart from a bottom of the main body 21. The through hole 214 is formed through a bottom surface of the chamber 212 and the bottom of the main body 21 to form a body flange 213 between the bottom surface of the chamber 212 and the bottom of the main body 21. The concave recesses 216 are arranged around the chamber 212 and are connected with each other to form a multi-lobed groove. The concave recesses 216 communicate with the chamber 212 and extend downwardly from the top of the main body 21. A depth of each of the concave recesses 216 is smaller than a depth of the chamber 212. A diameter of a circumscribed circle of the multi-lobed groove is larger than a diameter of the chamber 212.

With reference to FIGS. 2 to 4, the retainer 30 is rotatably mounted in the chamber 212 of the main body 21. The retainer 30 has a base ring 31, multiple separating rods 33, and multiple roller containing spaces 32. The separating rods 33 are arranged annularly at angular intervals and extend upwardly from the base ring 31. The roller containing spaces 32 are formed between the separating rods 33. Each of the roller containing spaces 32 corresponds to a respective one of the concave recesses 216 in position and has an outer opening facing an outer periphery of the retainer 30 and an inner opening facing an inner periphery of the retainer 30, wherein the outer opening is larger than the inner opening. Preferably, a distance between two opposite side surfaces of each of the separating rods 33 is gradually decreased from the inner periphery to the outer periphery of the retainer 30, so each of the roller containing spaces 32 is gradually larger from the inner opening to the outer opening thereof. The base ring 31 of the retainer 30 has a ring flange 311 extending inwardly from an inner periphery of the base ring 31 to hold a tool holder. The ring flange 311 has an inner diameter being equal to an inner diameter of the body flange 213.

With reference to FIGS. 2 to 4, the rollers 35 are respectively and vertically placed in the roller containing spaces 32 of the retainer 30, Each of the rollers 35 is rotatably and movably retained between a corresponding one of the roller containing spaces 32 of the retainer 30 and a corresponding one of the concave recesses 216. Each of the rollers 35 is partially exposed from the inner opening of the corresponding roller containing space 32.

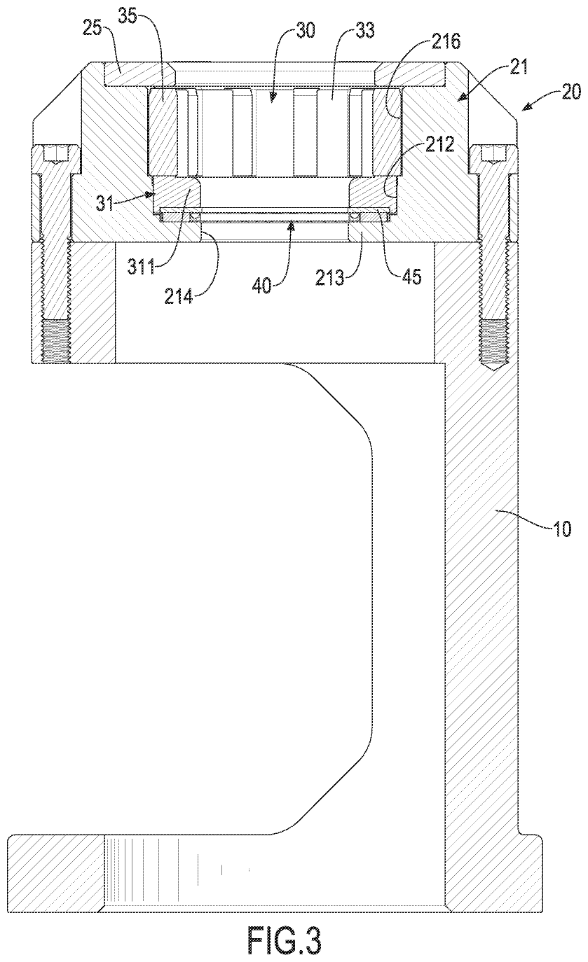

With reference to FIGS. 2 and 3, the end cover 25 is annular and is mounted on the top of the main body 21 to retain the retainer 30 and the rollers 35 between the main body 21 and the end cover 25.

Preferably, with reference to FIGS. 2 and 3, a thrust bearing 40 is mounted between the retainer 30 and the body flange 213 of the main body 21. The thrust bearing 40 has multiple needle rollers 41 arranged horizontally and radially. A washer 45 may be mounted between the thrust bearing 40 and the retainer 30. Friction resistance between the retainer 30 and the main body 21 can be reduced by the thrust bearing 40 mounted between the retainer 30 and the main body 21, so the retainer 30 can smoothly rotate relative to the main body 21.

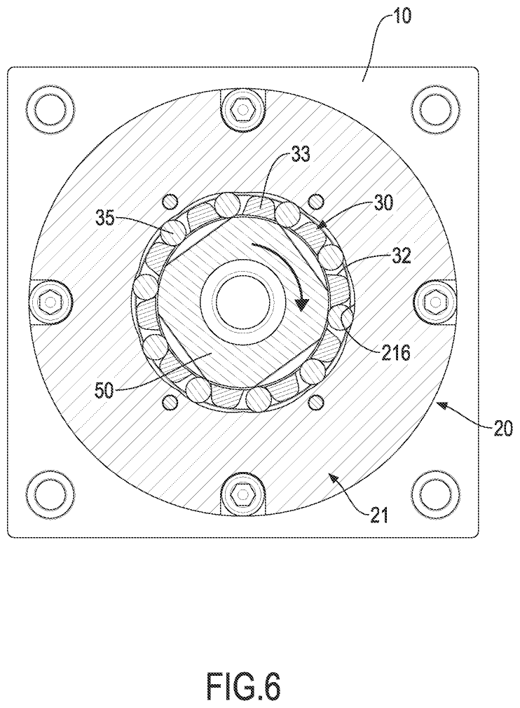

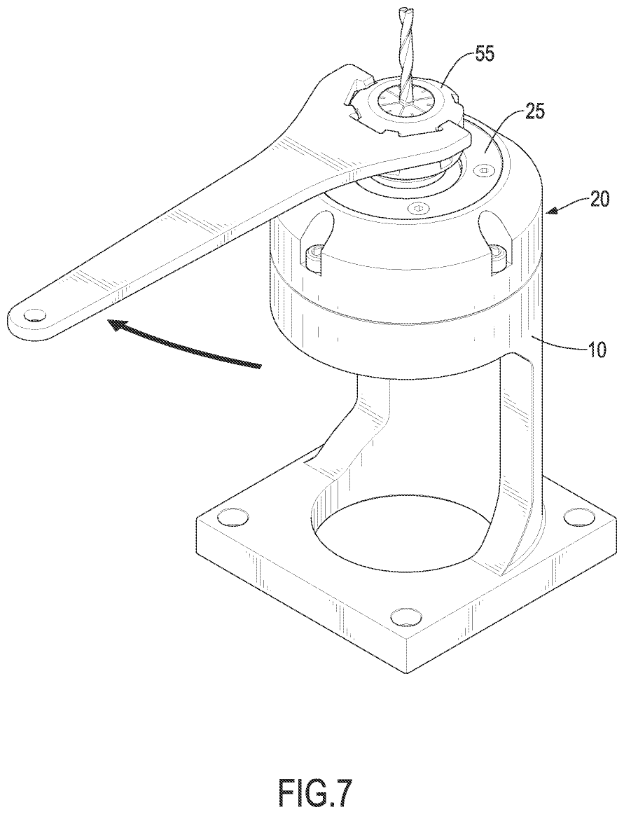

With reference to FIGS. 6 and 7, to use the tool holder bearing locking device, a tool holder 50 is inserted in the locking collar 20. The rollers 35 are pushed outwardly to move toward the concave recesses 216 by an outer peripheral surface of the tool holder 50. When the tool holder 50 is turned toward one direction (clockwise or counterclockwise), the retainer 30 and the rollers 35 are turned relative to the main body 21 by the tool holder 50. Whereby each of the rollers 35 is slid relative to the corresponding one of the concave recesses 216 to a position where a distance between the concave recess 216 and the outer peripheral surface of the tool holder 50 is smaller than or equal to a diameter of the roller 35. So the rollers 35 tightly abut against the outer peripheral surface of the tool holder 50, the corresponding concave recesses 216, and the corresponding separating rods 33 at the same time.

If the tool holder 50 is turned toward said direction any further at this time, the separating rods 33 of the retainer 30 will keep pushing the rollers 35 toward said direction, whereby the rollers 35 will keep abutting against the outer peripheral surface of the tool holder 50, Accordingly, the tool holder 50 and the retainer 30 abutting against the rollers 35 cannot be turned to rotate relative to the main body 21 in said direction. The tool holder 50 is fastened. A nut 55 connected on the tool holder 50 can be continuously turned toward said direction for fastening or loosening the nut 55 on the tool holder 50.

To loosen the tool holder 50, the tool holder 50 is turned toward a direction opposite to said direction. Each of the rollers 35 is slid to a position where a distance between the concave recess 216 and the outer peripheral surface of the tool holder 50 is larger than the diameter of the roller 35 to release the restriction between each of the rollers 35 and the tool holder 50.

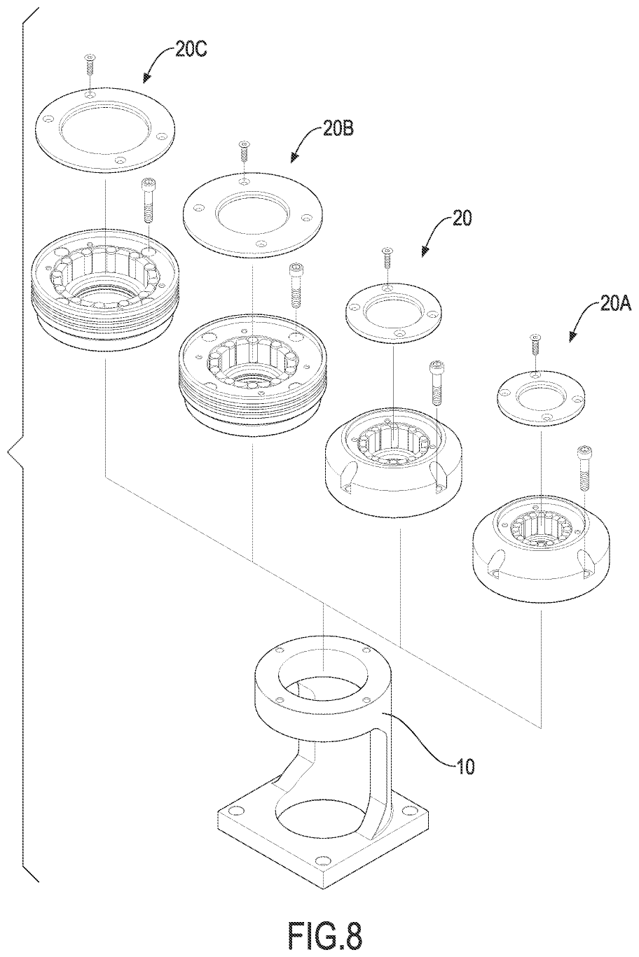

With reference to FIG. 8, a user can select one of the locking collars 20, 20A, 20B, 20C according to varying tool holder specifications to replace the locking collars 20, 20A, 20B, 20B mounted on the stand 10 for changing cutters in various tool holders.

With the above mentioned arrangements, the tool holder bearing locking device has simple structures and locks the tool holder 50 by the rollers 35 abutting against the tool holder 50 to avoid damaging the outer peripheral surface of the tool holder 50 while fixing the tool holder 50.

What is claimed is:

1. A tool holder bearing locking device comprising:
a stand; and
a locking collar mounted on a top of the stand and having
a main body mounted on the top of the stand and having
a chamber formed downwardly from a top of the main body and spaced apart from a bottom of the main body;
a through hole formed through a bottom surface of the chamber and the bottom of the main body to form a body flange between the bottom surface of the chamber and the bottom of the main body; and
multiple concave recesses arranged around the chamber, communicating with the chamber, and connected with each other to form a multi-lobed groove;
a retainer rotatable mounted in the chamber of the main body and having
a base ring;
multiple separating rods arranged annularly at angular intervals and extending upwardly from the base ring; and
multiple roller containing spaces formed between the separating rods, and each of the roller containing spaces corresponding to a respective one of the concave recesses in position and having an outer opening facing an outer periphery of the retainer and an inner opening facing an inner periphery of the retainer;
multiple rollers respectively and vertically mounted in the roller containing spaces of the retainer, each of the rollers rotatably and movably retained between a corresponding one of the roller containing spaces of the retainer and a corresponding one of the concave recesses of the main body and partially exposed from the inner opening of the corresponding roller containing space; and
an end cover mounted on the top of the main body to retain the retainer and the rollers between the main body and the end cover.

2. The tool holder bearing locking device as claimed in claim 1, wherein the locking collar is detachably mounted on the top of the stand.

3. The tool holder bearing locking device as claimed in claim 2, wherein a thrust bearing is mounted between the body flange of the main body and the retainer.

4. The tool holder bearing locking device as claimed in claim 3, wherein a washer is mounted between the retainer and the thrust bearing.

5. The tool holder bearing locking device as claimed in claim 1, wherein
the outer opening of each of the roller containing spaces is larger than the inner opening of the roller containing space; and
a distance between two opposite side surfaces of each of the separating rods is gradually decreased from the inner periphery to the outer periphery of the retainer.

6. The tool holder hearing locking device as claimed in claim 2, wherein
the outer opening of each of the roller containing spaces is larger than the inner opening of the roller containing space; and
a distance between two opposite side surfaces of each of the separating rods is gradually decreased from the inner periphery to the outer periphery of the retainer.

7. The tool holder bearing locking device as claimed in claim 3, wherein
the outer opening of each of the roller containing spaces is larger than the inner opening of the roller containing space; and
a distance between two opposite side surfaces of each of the separating rods is gradually decreased from the inner periphery to the outer periphery of the retainer.

8. The tool holder bearing locking device as claimed in claim 4, wherein
the outer opening of each of the roller containing spaces is larger than the inner opening of the roller containing space; and
a distance between two opposite side surfaces of each of the separating rods is gradually decreased from the inner periphery to the outer periphery of the retainer.

9. The tool holder bearing locking device as claimed in claim 5, wherein the base ring of the retainer has a ring flange extending inwardly from an inner periphery of the base ring.

10. The tool holder bearing locking device as claimed in claim 6, wherein the base ring of the retainer has a ring flange extending inwardly from an inner periphery of the base ring.

11. The tool holder bearing locking device as claimed in claim 7, wherein the base ring of the retainer has a ring flange extending inwardly from an inner periphery of the base ring.

12. The tool holder bearing locking device as claimed in claim 8, wherein the base ring of the retainer has a ring flange extending inwardly from an inner periphery of the base ring.
